(19) United States
(12) Patent Application Publication
(10) Pub. No.: US 2020/0025546 A1
(43) Pub. Date: Jan. 23, 2020

(54) Tape Measure Marking Attachment

(71) Applicants: Carlous Henderson, Riverview, FL (US); Joshua Henderson, Riverview, FL (US)

(72) Inventors: Carlous Henderson, Riverview, FL (US); Joshua Henderson, Riverview, FL (US)

(21) Appl. No.: 16/515,109

(22) Filed: Jul. 18, 2019

Related U.S. Application Data
(60) Provisional application No. 62/701,957, filed on Jul. 23, 2018.

(51) Int. Cl. G01B 3/10

(52) U.S. Cl. CPC G01B 3/1084; G01B 2003/1089

(57) ABSTRACT

A marking attachment for a tape measure is provided. The marking attachment includes a body having a base and at least a front wall and a rear wall defining an interior section. The interior section is proportioned to receive and frictional secure the tab from a tape measure therein. The rear wall may be flexibly attached to the base and is biased inwards. A pin may be located on the interior of the rear wall that locks into the tape measure tab. Alternatively, flexible tabs may be located on each of a pair of sidewalls to lock the attachment to the tape measure. A marking device is located on a bottom portion of the base of the attachment. The marking device may be a liquid marker, chalk, a pencil or a razor blade.

### CROSS REFERENCE TO RELATED APPLICATIONS

This application claims the benefit of U.S. Provisional Application No. 62/701,957 filed on Jul. 23, 2018. The above identified patent application is herein incorporated by reference in its entirety to provide continuity of disclosure.

### BACKGROUND OF THE INVENTION

The present invention relates to a tape measure marking attachment. More particularly, the present invention provides an attachment for a tape measure that allows an individual to use the same when marking an item that was just measured.

When working in construction or simply doing a household project, the need to measure and mark something is a constant. This constant is also a constant pain. Pencils or other marking devices always seem to be missing. Further, when working with different materials, different marking devices may be needed. People can spend a considerable amount of time looking for the correct marking implement to complete a measurement. This can not only slow down the pace of the project, but also cause an unnecessary headache. It can be time consuming and expensive to continuously purchase new marking devices. Additionally, typical marking devices have several drawbacks. Typical marking devices are held in the user's hand while in use, meaning the user's hands are unable to utilize an additional tool while marking. The process of retrieving a marking device and using it, then storing it and retrieving another tool, can be tiresome.

Consequently, there is a need in for an improvement in the art of measuring and marking items. The present invention substantially diverges in design elements from the known art while at the same time solves a problem many people face in measuring and marking items. In this regard the present invention substantially fulfills these needs.

### SUMMARY OF THE INVENTION

The present invention provides a tape measure marking attachment wherein the same can be utilized for providing convenience for the user when measuring and marking items. The present system comprises a body having a base and at least a front wall and a rear wall defining an interior section. The interior section is proportioned to receive and frictionally secure the tab from a tape measure therein. The rear wall may be flexibly attached to the base and is biased inwards. In one embodiment, a pin may be located on the interior of the rear wall such that it will lock into the tape measure tab. In another embodiment, flexible tabs may be located on each of a pair of sidewalls to lock the attachment to the tape measure. A marking device is located on a bottom portion of the base of the attachment. The marking device may be a liquid marker, chalk, a pencil or a razor blade.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the tape measure marking attachment in use.

FIG. 2 shows a perspective view of an embodiment of the tape measure marking attachment with flexible tabs and a cap.

FIG. 3 shows a cross-sectional view of an embodiment of the tape measure marking attachment with a locking pin.

FIG. 4 shows an exploded view of an embodiment of the tape measure marking attachment where the marking device is removable.

### DETAILED DESCRIPTION OF THE INVENTION

Reference is made herein to the attached drawings. Like reference numerals are used throughout the drawings to depict like or similar elements of the tape measure marking attachment. For the purposes of presenting a brief and clear description of the present invention, a preferred embodiment will be discussed as used for securing a marking device to a tape measure such that both tools can be utilized simultaneously. The figures are intended for representative purposes only and should not be considered to be limiting in any respect.

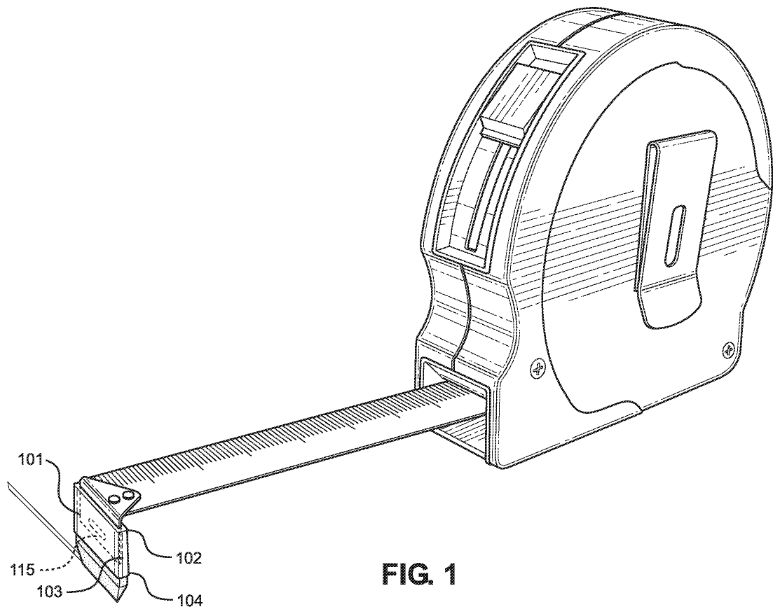

Referring now to FIG. 1, there is shown a perspective view of an embodiment of the tape measure marking attachment in use. A traditional tape measure includes a tongue 115 attached to the front end of the tape. The marking attachment includes a body that has a base 104 and at least a front wall 101 and rear wall 102 attached to the base 104. In other embodiments the marking attachment also has two side walls 103 attached to the base 104, such that the front wall 101, the rear wall 102, and the side walls 103 form a body having an interior volume accessible via an open upper end and an open lower end. The front wall 101, the rear wall 102, and the side walls 103 are configured to define an interior volume that can accept the tongue of a tape measure therein, such that the body is frictionally secured to the tongue 115 of the tape measure.

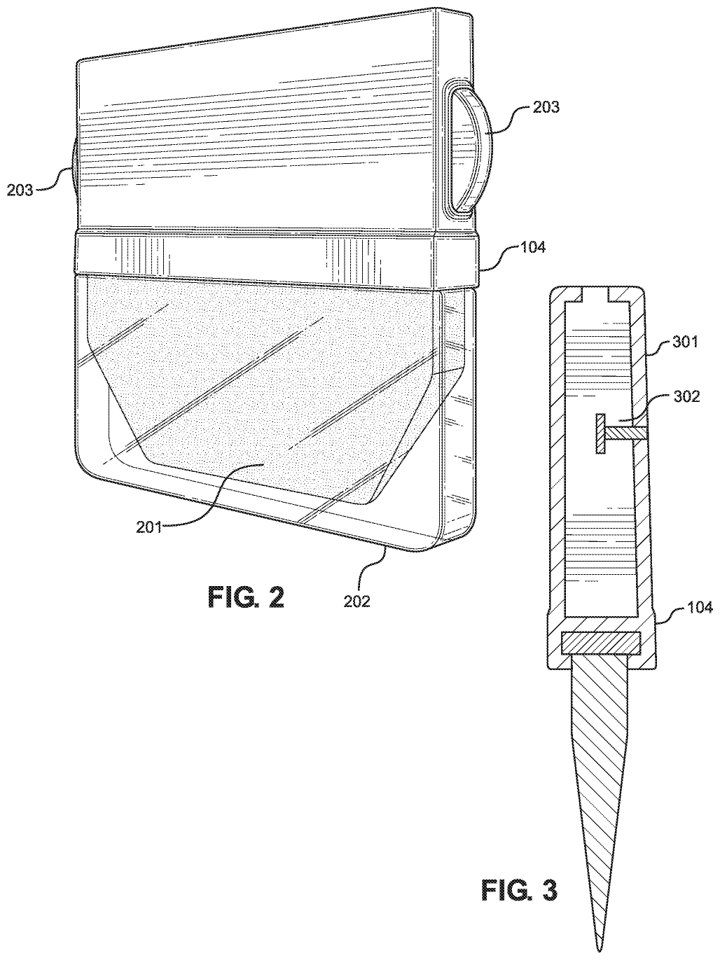

Referring now to FIG. 2, there is shown a perspective view of an embodiment of the tape measure marking attachment with flexible tabs and a cap. The marking attachment has a marking device 201 attached to the exterior of the base 104. In one embodiment the marking device is a pencil. In another embodiment the marking device is a liquid marker. In another embodiment the marking device is chalk. In another embodiment the marking device is a razor blade or other scoring device. In the shown embodiment, the marking device includes a tapered construction, such that an upper end of the marking device includes a width greater than a width of a lower end of the marking device.

In one embodiment, a cap 202 is removably securable to the body such that it is disposed overtop of and covers the marking device 201. In one embodiment, the cap 202 is held in place via friction. In another embodiment, the cap 202 is configured to clip onto the marking attachment. In one embodiment, the cap 202 is air tight to prevent a liquid marker from drying out. In another embodiment, the cap 202 is composed of a shatter resistant material to protect the marking device.

In one embodiment there are flexible tabs 203 located on the side walls 103. In this embodiment the side walls 103 have holes located therein. The holes are configured to accept the flexible tabs 203 therein. The flexible tabs 203 are biased inwardly such that the flexible tabs 203 apply pressure to the tongue of the tape measure, holding the marking attachment in place.

Referring now to FIG. 3, there is shown a cross sectional view of an embodiment of the tape measure marking attachment with a locking pin. In one embodiment, the marking attachment has a flexible rear wall 301. The flexible rear wall 301 is attached to the base 104 of the marking attachment at an inward angle such that the flexible rear wall is biased inwardly and applies pressure to the tape measure tongue. There is a pressure pin 302 attached to the interior of the rear wall 301. In one embodiment, the pressure pin 302 is proportioned to fit into a notch of the tape measure tongue. In another embodiment, the pressure pin 302 has a rubber surface to grip the tape measure tongue. The pressure pin 302 prevents the marking attachment from falling off of or otherwise separating from the tape measure tongue.

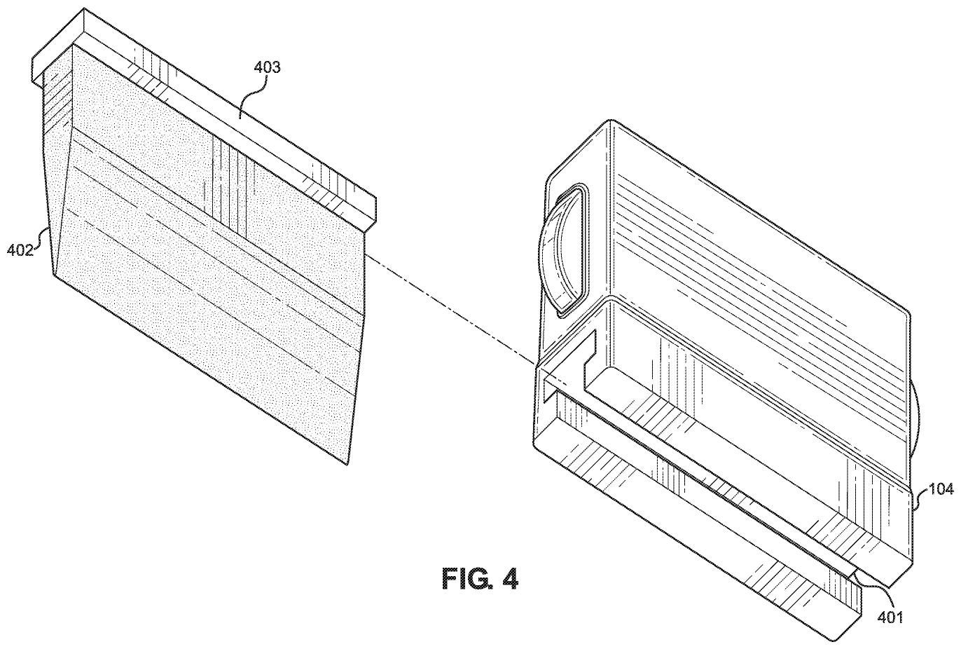

Referring now to FIG. 4, there is shown an exploded view of an embodiment of the tape measure marking attachment where the marking device is removable. In an embodiment the base 104 of the marking attachment has a channel 401 located therein. In the shown embodiment, the channel 401 includes a cross-sectional area that defines a T-shaped cut out. In this embodiment, the marking device 402 includes a T shaped attachment 403 disposed on a top section of the marking device 402. Further, in this embodiment, the channel 401 is configured to accept the T-shaped attachment 403, thereby allowing the marking device to be removably attached to the marking attachment. This allows the marking device to be changed with other marking devices.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

We claim:

1. A marking attachment for a tape measure, comprising:
a body having a base, a front wall, a pair of sidewalls, and a rear wall defining an interior volume, wherein the interior volume is proportioned to receive and frictional secure tab of a tape measure therein;
wherein the rear wall is flexibly attached to the base and is biased inwards;
a pin disposed on an interior surface of the rear wall, the pin configured to extend into the tape measure tab to lock the body to the tape measure tab;
a marking device disposed on a bottom portion of the base.

2. The marking attachment for a tape measure of claim 1, wherein the marking device is an ink marker.

3. The marking attachment for a tape measure of claim 1, wherein the marking device is chalk.

4. The marking attachment for a tape measure of claim 1, wherein the marking device is a razor blade.

5. The marking attachment for a tape measure of claim 1, wherein the marking device is a pencil.

6. The marking attachment for a tape measure f claim 1, further comprising:
a channel located below the base portion, wherein an upper portion of the marking device is configured to be removably secured within the channel;

7. The marking attachment for a tape measure f claim 1, further comprising a removable cap that is configured to be removably secured over the marking device.

8. A marking attachment for a tape measure, comprising,
a body having a base, a front wall, a pair of side walls, and a rear wall defining an interior volume, wherein the interior volume is proportioned to receive the tab from a tape measure therein;
a flexible tab disposed on each sidewall of the pair of sidewalk, wherein the flexible tabs are configured to removably secure the attachment to the tape measure;
a marking device disposed on a bottom portion of the base.

9. The marking attachment for a tape measure of claim 8, wherein the marking device is an ink marker.

10. The marking attachment for a tape measure of claim 8, wherein the marking device is chalk.

11. The marking attachment for a tape measure of claim 8, wherein the marking device is a razor blade.

12. The marking attachment for a tape measure of claim 8, wherein the marking device is a pencil.

13. The marking attachment for a tape measure of claim 8, further comprising: a channel located below the base portion; wherein an upper portion of the marking device is configured to be removably secured in the channel.

14. The marking attachment for a tape measure of claim 8, further comprising a removable cap that is configured to be removably secured over the marking device.
